(19) United States
(12) Patent Application Publication
(10) Pub. No.: US 2024/0400890 A1
(43) Pub. Date: Dec. 5, 2024

(54) DIALKYL AND CYCLIC CARBONATE-DERIVED SOLVENT FORMULATIONS FOR CHEMICAL APPLICATIONS IN MITIGATING CONDENSATE BANKING

(71) Applicant: Baker Hughes Oilfield Operations LLC, Houston, TX (US)

(72) Inventors: Onome Ugono, Rosenberg, TX (US); Sankaran Murugesan, Katy, TX (US); Kekeli A. Ekoue-Kovi, Rosenberg, TX (US)

(73) Assignee: Baker Hughes Oilfield Operations LLC, Houston, TX (US)

(21) Appl. No.: 18/203,608

(22) Filed: May 30, 2023

(51) Int. Cl. C09K 8/86; C09K 8/60

(52) U.S. Cl. CPC C09K 8/86; C09K 8/602

(57) ABSTRACT

A formulation and method for the remediation of condensate banking. In one aspect, a condensate banking treatment formulation is disclosed, wherein the formulation includes an organic carbonate, having a dialkyl or cyclic carbonate, and a surfactant. In another aspect, a method is described for remediating a region of a wellbore impacted by petroleum condensate banking. The method includes the step of preparing a condensate banking treatment formulation, which includes providing an organic carbonate having a dialkyl or cyclic carbonate and mixing the organic carbonate with a surfactant. The method further includes applying the condensate banking treatment formulation to the region of the wellbore impacted by the petroleum condensate banking. In another aspect, a condensate banking treatment formulation is disclosed having propylene carbonate and an alcohol oxyalkylate, wherein the ratio of the propylene carbonate to the alcohol oxyalkylate is between about 1:20 to about 20:12.

### FIELD OF THE INVENTION

The present application is generally directed at methods and compositions for mitigating condensate banking and more particularly, but not by way of limitation, to methods and compositions for remediating condensate banking.

### BACKGROUND

Condensate banking is a phenomenon in gas-producing reservoirs that can create significant and costly declines in well productivity. When bottomhole pressure decreases below dewpoint pressure, condensate (usually hydrocarbon) can liquefy out of the vapor phase in the near-wellbore region and adhere to porous rock surfaces. This causes liquid condensate to accumulate near the wellbore and in the reservoir. The accumulation of condensate creates a blockage that can slow or block the flow of hydrocarbons out of the reservoir, thereby reducing gas permeability and gas production for the well. To maintain the efficient production of petroleum products, it is important to remove the blockages in regions of reduced relative permeability.

Several methods have been developed to address condensate banking. Some methods focus on maintaining bottomhole pressure above the dewpoint to prevent the initial dropping out of condensate from the vapor phase. Inhibitors may be injected to prevent condensate formation for a period of time. Other methods aim to remove existing condensate blockage. For example, acids may be used to create or open additional pathways for oil and gas. Surfactants or solvents such as ethanol, methanol, and isopropyl alcohol may also be used to alter wettability and, thereby, remove the condensate around a wellbore and inhibit condensate formation within certain ranges of temperature and pressure.

Many of the above treatment methods are costly to implement. Further, the introduction of certain inhibitors or acids may have undesirable impacts on the environment. It is, therefore, a continuing goal to improve treatments for condensate banking and, in particular, to develop a cost-effective, environmentally friendly treatment to remediate condensate blockage.

### SUMMARY OF THE INVENTION

The inventive concepts disclosed are generally directed to the remediation of condensate banking with organic carbonate formulations. In one aspect, a condensate banking treatment formulation is disclosed, wherein the formulation includes an organic carbonate, wherein the organic carbonate has a dialkyl or cyclic carbonate, and a surfactant.

In another aspect, a method is described for remediating a region of a wellbore impacted by petroleum condensate banking. The method includes the steps of preparing a condensate banking treatment formulation, which includes providing an organic carbonate that has a dialkyl or cyclic carbonate and mixing the organic carbonate with a surfactant. The method further includes applying the condensate banking treatment formulation to the region of the wellbore impacted by the petroleum condensate banking.

In another aspect, a condensate banking treatment formulation is disclosed having propylene carbonate and an alcohol oxyalkylate, wherein the ratio of the propylene carbonate to the alcohol oxyalkylate is between about 1:20 to about 20:1.

### DETAILED DESCRIPTION

It has been discovered that certain organic carbonate formulations present a cost-effective solution for the remediation of condensate banking in a well drilled for the production of petroleum products. In some embodiments, a condensate banking treatment formulation includes a dialkyl or cyclic carbonate and a surfactant. In these embodiments, the condensate banking treatment formulation optionally includes a co-solvent.

Suitable dialkyl and cyclic carbonates are characterized by a high flash point and good solvent properties. In some embodiments, one or more dialkyl carbonates are used in combination with one or more cyclic carbonates. Suitable dialkyl carbonates include dimethyl carbonate, diethyl carbonate, dibutyl carbonate, and combinations thereof. Suitable cyclic carbonates include propylene carbonate, ethylene carbonate, glycerol carbonate, and combinations thereof. These organic carbonates have a mutual solvent property in the condensate banking treatment formulation. In an exemplary embodiment, the organic carbonate is propylene carbonate.

The surfactant component of the condensate banking treatment formulation may include one or more of the following surfactants: alkanolamides, phenol oxyalkylates, alcohol oxyalkylates, alkylamine oxyalkylates, alkyl glycosides, alkyl sulfonates, aryl sulfonates, and combinations thereof.

The condensate banking treatment formulation optionally includes a co-solvent to improve the miscibility between the organic carbonate and the surfactant. Suitable co-solvents include, but are not necessarily limited to, C1-C8 mono-and polyhydric alcohols including, but not particularly restricted to, methanol (MeOH), ethanol, 2-propanol, butanol, 2-ethylhexanol, ethylene glycol, diethylene glycol, and glycerol. In one suitable non-limiting embodiment the co-solvent is methanol.

In some embodiments, the condensate banking treatment formulation includes between about 1 weight (wt.) % to about 10 wt. % organic carbonate and between about 30 wt. % and about 80 wt. % surfactant. In one particular embodiment, the condensate banking treatment formulation includes about 5 wt. % propylene carbonate and about 46 wt. % surfactant. In other embodiments, the ratio of the dialkyl or cyclic carbonate to the surfactant in the condensate banking treatment formulation is between about 1:20 to about 20:1. In other embodiments, the ratio of the dialkyl or cyclic carbonate to the surfactant in the condensate banking treatment formulation is approximately 1:10.

In embodiments in which the condensate banking treatment formulation includes a co-solvent, the co-solvent can be present in the condensate banking treatment formulation in amounts between approximately 5 wt. % and approximately 50 wt. % with reference to the condensate banking treatment formulation. In some embodiments, the co-solvent is present in the amount of approximately 20 wt. %. In other embodiment, the co-solvent is present at approximately 5 wt. %. For instance, in an exemplary non-limiting embodiment, the condensate banking treatment formulation includes about 5 wt. % cyclic carbonate, about 46 wt. % surfactant, and about 5 wt. % co-solvent.

As used herein, ranges of concentration ratios should be interpreted to include any and all ratios within the prescribed ranges. For example, embodiments where the ratio of dialkyl or cyclic carbonate to surfactant is expressed within the range of about 1:20 to about 20:1 should be interpreted to also include the discrete intermediate concentrations ratios of 1:19, 1:18, . . . , 18:1, 19:1 (dialkyl or cyclic carbonate: surfactant), and fractional ratios therebetween (e.g., 1:19.1, 1:19.2, 18.5:1, and 19.5:1)). It will be understood that, as used herein, a range of X wt. % to Y wt. % will be interpreted to include the disclosure of each discrete integer value between X and Y (e.g., X, X+1, X+2. . . . Y−1, Y)

The condensate banking treatment formulation can be delivered to the impacted region of the well in a concentrated form by injection through capillary tubing, chemical injection plunger, or other treatment chemical delivery mechanisms. Alternatively, the condensate banking treatment formulation can be mixed with a suitable carrier fluid and pumped into the wellbore. The carrier fluid may be water, brine, or another aqueous solution. In other embodiments, the carrier fluid may be an aromatic solvent. In some applications, it may be desirable to add the condensate banking treatment formulation to the aqueous carrier fluid in a concentration range of between about 50 to 90 gallons of condensate banking treatment formulation to about 10 to 60 gallons of carrier fluid.

Although the condensate banking treatment formulations disclosed herein are particularly effective at removing condensate banking in the wellbore or near wellbore, the condensate banking treatment formulation may also find utility in treating surface-based facilities and equipment. Moreover, although this disclosure has thus far been directed to the use of the disclosed formulation for the treatment of condensate banking, it will be appreciated that the formulation may also be applied to water banking situations.

Although the foregoing specification describes various embodiments of the condensate banking treatment formulation and various methods for using the condensate banking treatment formulation, it will be evident that various modifications and changes can be made thereto without departing from the broader scope of the invention as set forth in the appended claims. Accordingly, the specification is to be regarded in an illustrative rather than a restrictive sense. For example, different dialkyl and cyclic carbonates and surfactants, treatment procedures, proportions, dosages, temperatures, and amounts not specifically identified or described in this disclosure are still contemplated as falling within the scope of this invention.

The present invention may suitably comprise, consist of, or consist essentially of the elements disclosed and may be practiced in the absence of an element not disclosed. As used herein, the singular forms “a,” “an,” and “the” are intended to include the plural forms as well, unless the context clearly indicates otherwise. As used herein, the term “about” in reference to a given parameter is inclusive of the stated value and has the meaning dictated by the context (e.g., it includes the degree of error associated with measurement of the given parameter). As used herein, the term “and/or” includes any and all combinations of one or more of the associated listed items.

1. A condensate banking treatment formulation comprising:
an organic carbonate, wherein the organic carbonate comprises a dialkyl or cyclic carbonate;
a surfactant; and
between about 20 wt. % and about 50 wt. % co-solvent.

2. The condensate banking treatment formulation of claim 1, wherein the dialkyl carbonate is selected from the group consisting of dimethyl carbonate, diethyl carbonate, dibutyl carbonate, and combinations thereof.

3. The condensate banking treatment formulation of claim 1, wherein the cyclic carbonate is selected from the group consisting of propylene carbonate, ethylene carbonate, glycerol carbonate, and combinations thereof.

4. The condensate banking treatment formulation of claim 1, wherein the surfactant is selected from the group consisting of alkanolamides, phenol oxyalkylates, alcohol oxyalkylates, alkylamine oxyalkylates, alkyl glycosides, alkyl sulfonates, aryl sulfonates, and combinations thereof.

5. (canceled)

6. The condensate banking treatment formulation of claim 1 claim 5, wherein the co-solvent is methanol.

7. The condensate banking treatment formulation of claim 1, wherein the condensate banking treatment formulation comprises:
from about 1 wt. % to about 10 wt. % cyclic carbonate; and
from about 30 wt. % to about 80 wt. % surfactant; and
from about 5 wt. % to about 50 wt. % co solvent.

8. The condensate banking treatment formulation of claim 7, wherein the cyclic carbonate is propylene carbonate.

9. The condensate banking treatment formulation of claim 8, wherein the surfactant is alcohol oxyalkylate, wherein the condensate banking treatment formulation comprises:
about 5 wt. % propylene carbonate; and
about 46 wt. % alcohol oxyalkylate;

10. The condensate banking treatment formulation of claim 1, wherein the ratio of the dialkyl or cyclic carbonate to the surfactant is between about 1:20 to about 20:1.

11. The condensate banking treatment formulation of claim 10, wherein the ratio of the dialkyl or cyclic carbonate to the surfactant is approximately 1:10.

12. A method for remediating a region of a wellbore impacted by petroleum condensate banking, the method comprising the steps of:
preparing a condensate banking treatment formulation, wherein the step of preparing the condensate banking treatment formulation comprises:
providing an organic carbonate, wherein the organic carbonate is a dialkyl or cyclic carbonate; and
mixing the organic carbonate with a surfactant; and
applying the condensate banking treatment formulation to the region of the wellbore impacted by the petroleum condensate banking.

13. The method of claim 12, wherein the step of applying the condensate banking treatment formulation further comprises injecting the condensate banking treatment formulation in a concentrated form to the region of the wellbore impacted by the petroleum condensate banking.

14. The method of claim 13, wherein the step of applying the condensate banking treatment formulation comprises injecting the condensate banking treatment formulation through capillary tubing to the region of the wellbore impacted by the petroleum condensate banking.

15. The method of claim 12, further comprising a step of mixing the condensate banking treatment formulation with a carrier fluid before the step of applying the condensate banking treatment formulation to the region of the wellbore impacted by the petroleum condensate banking.

16. The method of claim 12, wherein the dialkyl or cyclic carbonate is selected from the group consisting of propylene carbonate, dimethyl carbonate, diethyl carbonate, dibutyl carbonate, ethylene carbonate, glycerol carbonate, and combinations thereof.

17. The method of claim 12, wherein the surfactant comprises at least one surfactant selected from the group consisting of alkanolamides, phenol oxyalkylates, alcohol oxyalkylates, alkylamine oxyalkylates, alkyl glycosides, alkyl sulfonates, and aryl sulfonates.

18. The method of claim 12, wherein the ratio of the dialkyl or cyclic carbonate to the surfactant is between about 1:20 to about 20:1.

19. A condensate banking treatment formulation comprising:
propylene carbonate;
an alcohol oxyalkylate; and
between about 20 wt. % and about 50 wt. % co-solvent,
wherein the ratio of the propylene carbonate to the alcohol oxyalkylate is between about 1:20 to about 20:1.

20. The condensate banking treatment formulation of claim 19, wherein the ratio of the propylene carbonate to the alcohol oxyalkylate is approximately 1:10.

21. The condensate banking treatment formulation of claim 4, wherein the surfactant is selected from the group consisting of alkanolamides, phenol oxyalkylates, alkylamine oxyalkylates, alkyl glycosides, and combinations thereof.

22. The condensate banking treatment formulation of claim 19, wherein the co-solvent is selected from the group consisting of ethanol, 2-propanol, butanol, 2-ethylhexanol, ethylene glycol, diethylene glycol, and glycerol.
